(19) United States
(12) Patent Application Publication
(10) Pub. No.: US 2010/0090041 A1
(43) Pub. Date: Apr. 15, 2010

(54) DRY PARTICLE SUPPLYING DEVICE FOR PARTICLE-SIZE MEASURING APPARATUS

(76) Inventor: Miroslav Pejcinovic, Lake Forest, CA (US)

Correspondence Address: SNELL & WILMER LLP (OC), 600 ANTON BOULEVARD, SUITE 1400, COSTA MESA, CA, 92626, US

(21) Appl. No.: 12/528,764

(22) PCT Filed: May 22, 2007
(86) PCT No.: PCT/US07/69476

§ 371 Date: Aug. 26, 2009

(51) Int. Cl. B02C 23/10

(52) U.S. Cl. 241/69; 241/68; 241/79.3

(57) ABSTRACT

A dry particle supplying device for a particle-size measuring apparatus for providing an elementary dispersion of dry particle samples into an elementary particle state during the initial introduction of the dry particle sample into the measuring apparatus. The device comprising a feeder unit, a separation unit, and a retention device. The feeder unit vibrating due to a vibration force which allows the separation unit adjacent the retention device to pulverize samples in aggregated groups into an elementary particle state.

### BACKGROUND OF THE INVENTION

1. Field of the Invention

The invention relates to a dry particle supplying device for a particle-size measuring apparatus and more particularly, to an improved dry particle supplying device for providing a dispersion of dry particle samples into an elementary particle state during the initial introduction of the dry particle sample into the measuring apparatus.

2. Description of Related Art

In a dry particle-size distribution measuring apparatus, a feeder unit usually accommodates a powdery and particulate sample in a sample supplying device. A user typically places the sample into a hopper, which then distributes the sample to the feeder unit. The purpose of the feeder unit is to regulate the flow rate of the sample being delivered to the measuring unit.

The feeder unit is then vibrated to move the sample from a sample receiving portion of the feeder unit to a sample delivery portion of the feeder unit. From the sample delivery portion of the feeder unit, the sample drops down a chute to undergo the final dispersion into elementary particles, usually achieved using compressed air, and to be measured by the measuring apparatus.

However, the samples can oftentimes have the elementary particles adhere together to be aggregated in groups as opposed to remaining in an elementary particle state. For example, the groups can form through electrostatic force, a Van der Waals force, a magnetic force, or other similar forces which act among the powdery and particulate members, even in a dry state. The effect is that the powdery and particulate members are not in a form of elementary particles, but rather as secondary particles in which several elementary particles are aggregated or tertiary particles in which several secondary particles are aggregated and so on.

This causes fluctuations of the sample flow and sample dispersion which can lead to errors when the measuring apparatus is attempting to measure and analyze the sample. For example, the measuring apparatus could report an aggregated group of particles as one particle or fail to count the aggregated group of particles at all. In both scenarios, the measuring apparatus' measurements would be inaccurate.

U.S. Pat. No. 7,042,557 discloses one approach to separating clusters of particles into an elementary state.

However, there is still a need for a dry particle supplying device that can better supply particles, in a homogeneous elementary state and at a continuous flow rate, to measuring apparatuses.

### SUMMARY OF THE INVENTION

The present invention seeks to solve the problems presented above by efficiently reducing a sample into an elementary particle state more suitable for the consecutive dispersion and measuring steps. It can also better regulate the flow of the sample from the sample receiving portion to the sample delivery portion. It utilizes a feeder unit, a retention device, and a separation unit. The feeder unit can receive and deliver a sample. The feeder unit can include a sample receiving portion, a sample delivery portion, and a bottom support surface.

The retention device can be operatively positioned in the feeder unit for example by being connected to the feeder unit, wherein the retention device is intermediate the sample receiving portion and the sample delivery portion of the feeder unit. The retention device can also be positioned a predetermined distance from the bottom support surface upstream of the sample delivery portion of the feeder unit.

The separation unit can further be located adjacent the retention device on the side encompassing the sample receiving portion of the feeder unit. The separation unit can crush aggregated groups of the sample to an elementary particle state before the sample passes from the sample receiving portion of the feeder unit past the retention device and into the sample delivery portion of the feeder unit. The weight of the separation unit could be particularly advantageous for crushing the aggregated groups of the sample to an elementary particle state. The sample can be particles which can have, for example, a diameter ranging from approximately 10 nm to 3 mm.

A user can place a sample of particles directly into the sample receiving portion of the feeder unit. This eliminates the need for a hopper to feed the sample into the feeder unit. Alternately, samples can be fed by a hopper. The feeder unit would then be vibrated with a vibration usually aligned at an angle to the feeder unit.

The sample is propagated in the desired direction by the vibration force of the feeder unit. The vibration is in an angled vertical direction and goes relatively upwards and then relatively downwards. The result of this vibration is that the sample propagates from the sample receiving unit through the separation unit to the sample delivery unit.

The vibration also rotates the separation unit, allowing it to separate the samples into an elementary particle state and also aids in propagating the sample. During the downward part of the vibration cycle while the feeder unit moves in a downwards angle, the separation unit moves in a downwards angle due to the combination of gravity and the force exerted on separation unit through the retention device.

In the upward part of the vibration cycle the feeder unit moves in an upwards angle makes contact with the separation unit and bounces it in approximately same upwards angle as the angle of vibration.

Due to the interaction of the inertia of the separation unit and gravitational force which moves the separation unit downwards, on one side, combined with the upwards angled force supplied by the feeder unit when it contacts the separation unit, on the other side, the separation unit not only crushes the sample aggregates underneath the separation unit into an elementary particle state, but also rotates. This rotational movement aids in propagating the sample from the sample receiving portion towards the sample delivery portion which adds a new dimension to the sample supply process not present in the case of a conventional hopper delivery system.

Preferably the angle of the retention device is the same angle as the angle of vibration. This may reduce the extraneous movement of the separation unit and help keep it relatively closely positioned to the retention device. This also assures that the retention device contacts the separation unit mostly while the separation unit is falling towards the feeder unit. This contributes to the mentioned rotation of the separation unit. The retention device could also, for example, aide in regulating the sample flow rate from the sample receiving portion to the sample delivery portion. In addition, an optional guard device may be added to the retention device upstream of the separation unit to help keep the separation unit relatively close to the retention device and optionally regulate the sample flow rate towards the separation unit.

The separation unit can comprise a cylindrical core with a peripheral textured surface. The textured surface can have a plurality of grooves on it such as spiral grooves. The grooves can aid in crushing the sample into elementary particles, for example by, allowing the force from the textured surface to be more concentrated when the textured surface contacts the samples. This can allow the textured surface to be more effective in crushing the samples into elementary particles since there is a smaller surface area contacting the object while utilizing the same amount of force. The grooves could also, for example, allow the textured surface to better target the aggregated groups of the sample which are not elementary particles to crush them into elementary particles since the sample which are already elementary particles can enter the grooves and be momentarily hidden from the crushing force of the textured surface. The spiral grooves can also be formed to prevent the separation unit from catching onto the retention device when the separation unit is rotating. The texture of the outside surface of the separation unit can determine the elementary particle size. In addition, the separation unit can be coated with a non-stick substance such as Teflon® to prevent the sample from sticking to the separation unit. Different separation devices may be used for different kind of samples.

Also, additives such as fumed silica flow agent Aerosil® 200 may be added to aid in reducing the adhesive properties of the sample. This could allow the sample to flow better and to reduce the potential for the sample to stick to the separation unit. A brush as disclosed in Yamaguchi et al. (U.S. Pat. No. 7,042,557) may be added to the feeder unit to further aid in reducing the samples into an elementary particle state and prevent particle agglomeration downstream of the separation unit.

Furthermore, the vibration force can be varied in response to the rate of the sample flowing into the sample delivery portion. For example, if the rate of the sample flowing into the sample delivery portion is reduced, the vibration force can be increased to propagate the sample faster into the sample delivery portion. This could also have the added benefit of reducing the amount of samples that stick to the separation unit or dislodging samples that were stuck to the separation unit.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings.

FIG. 1 is a perspective view of an embodiment of the invention;

FIG. 2 is a side view of FIG. 1 take along section line 2-2;

FIG. 3 is a close-up view of a relevant portion of FIG. 2;

FIG. 4 is a close-up view of a relevant portion of FIG. 3;

FIG. 5 is a close-up view of a relevant portion of FIG. 4;

FIG. 6 is a perspective view of an alternate embodiment of the invention;

FIG. 7 is a perspective view of the separation unit adjacent the retention device;

FIG. 8 is a schematic diagram of a dry particle-size distribution measuring apparatus into which the feeder unit can be incorporated; and

FIG. 9 is a cross-sectional perspective view of an alternate embodiment of the separation unit adjacent the retention device.

### DETAILED DESCRIPTION OF THE PREFERRED EMBODIMENTS

Reference will now be made in detail to the preferred embodiments of the invention which set forth the best modes contemplated to carry out the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

FIG. 1 is a perspective view of an embodiment of the invention. The invention utilizes a feeder unit 2 which has a sample receiving portion 6, a sample delivery portion 4, and a bottom support surface 48. Feeder unit 2 can also have side walls 38 and 40. Sample 8 can also be seen inside the sample receiving portion and can be numerous particles which can have, for example, a diameter ranging from approximately 10 nm to 3 mm. Separation unit 12 is located adjacent retention device 10. It is contemplated but not necessary that there is a gap between the retention device 10 and the side walls 38 and 40, to improve flexibility of the retention device 10. The retention device 10 can also be raised a predetermined distance from the feeder unit 2. Separation unit 12 can have, for example, a cylindrical core 18 with a textured surface 14 and a plurality of spiral grooves 16.

A user would place the sample 8 directly into the sample receiving portion 6 of the feeder unit 2. This eliminates the need for a hopper to feed the sample 8 into the feeder unit 2. The feeder unit 2 would then be vibrated with the vibration 20 coming at an angle 42 as shown in FIG. 3.

Due to the vibration force, the sample 8 moves from the sample receiving portion 6 to the separation unit 12 located adjacent the retention device 10. The separation unit 12 crushes aggregated groups of the sample 8 to an elementary particle state before the sample 8 passes from the sample receiving portion 6 of the feeder unit 2 past the retention device 10 and into the sample delivery portion 4 of the feeder unit 2.

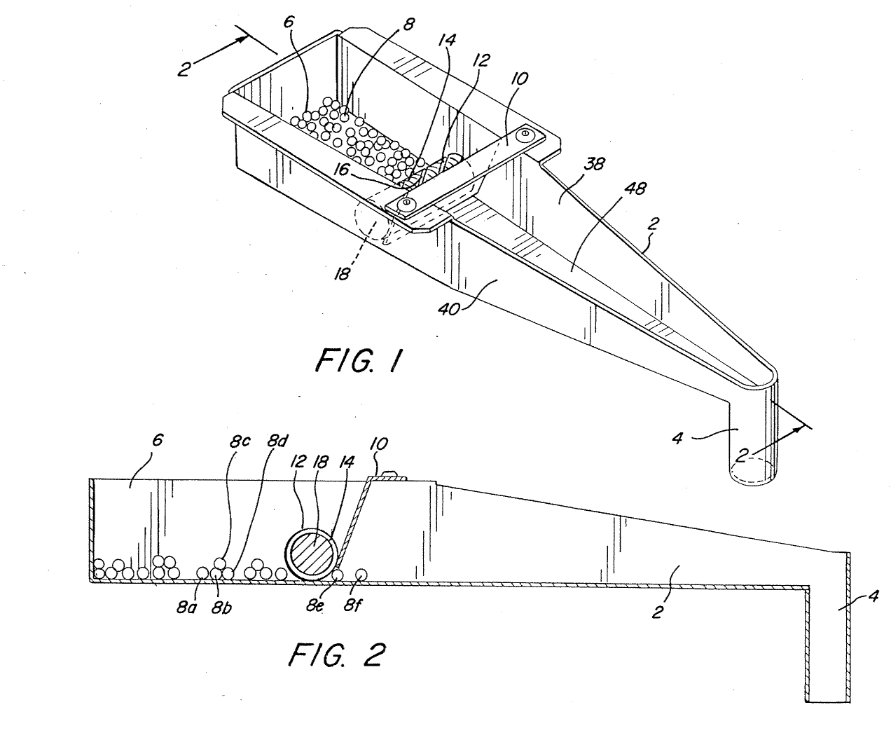

FIG. 2 is a side view of FIG. 1 take along section line 2-2. It depicts the feeder unit 2 with a sample receiving portion 6 and a sample delivery portion 4. FIG. 2 also shows a separation unit 12 with a cylindrical core 18 and a textured surface 14. Separation unit 12 could be located adjacent the retention device 10.

FIG. 2 also depicts the feeder unit 2, the separation unit 12, the retention device 10, and samples 8a, 8b, 8c, 8d, 8e, and 8f. Samples 8a, 8e, and 8f are in an elementary particle state while samples 8b, 8c, and 8d are in different aggregated stages. Although the separation unit 12 and the retention device 10 are at a spaced distance from the sample delivery portion 4, it is contemplated that the separation unit and the retention device could also be located adjacent the sample delivery portion 4 or anywhere else intermediate the sample receiving portion 6 and the sample delivery portion 4.

FIG. 3 is a close-up view of a relevant portion of FIG. 2. FIG. 3 shows the feeder unit 2 with a separation unit 12 adjacent retention device 10 and sample 8. Retention device 10 is raised a predetermined distance 46 from the feeder unit 2. The predetermined distance 46 should be large enough such that the sample 8 can sufficiently pass through the retention device 10 and small enough to reduce the possibility of the separation unit 12 catching on the retention device 10.

A vibration force 20 with an angle 42 with respect to the bottom 48 of feeder unit 2 acts on feeder unit 2. Retention device 10 is situated at an angle 22 with respect to feeder unit 2. Angle 22 is an acute angle between the retention device 10 and the bottom of the feeder unit 2 when the retention device 10 and the bottom 48 of the feeder unit 2 are viewed from the sample delivery portion 4 of the feeder unit 2 and angle 22 is an obtuse angle between the retention device 10 and the bottom 48 of the feeder unit 2 when the retention device 10 and the bottom 48 of the feeder unit 2 are viewed from the sample receiving portion 6 of the feeder unit.

During the upward part of the vibration cycle 20 the feeder unit moves in an upwards angle, and during the downward part of the vibration cycle 20 the feeder unit moves in a downwards angle. The result is that the sample propagates from the sample receiving unit through the separation unit to the sample delivery unit.

The vibration 20 also rotates the separation unit 12 in a rotational direction 30 allowing the separation unit 12 to separate the samples into an elementary particle state and also to aid in propagating the sample. During the downward part of the vibration cycle 20 while the feeder unit 2 moves in a downwards angle 42, the separation unit moves at a downwards angle 26.

In the upward part of the vibration cycle 20 the feeder unit moves in an upwards angle 24.

Due to the force and momentum created through the interaction of the inertia of the separation unit 12 and gravitational force which moves the separation unit 12 downwards, on one side, and the upwards angled force supplied by the feeder unit 2 when it contacts the separation unit 12, on the other side, the separation unit 12 not only crushes the sample aggregates underneath the separation unit into an elementary particle state, but also rotates in a rotational direction 30. This rotational movement aids in propagating the sample from the sample receiving portion 6 (shown in Figures and 2) on the left side towards the sample delivery portion 4 (shown in FIGS. 1 and 2) on the right side.

As can be seen, when the feeder unit 2 is viewed such that the sample receiving portion 6 of the feeder unit 2 is on the left side and the sample delivery portion 4 of the feeder unit 2 is on the right side, the separation unit 2 rotational direction 30 is in a counter-clockwise direction.

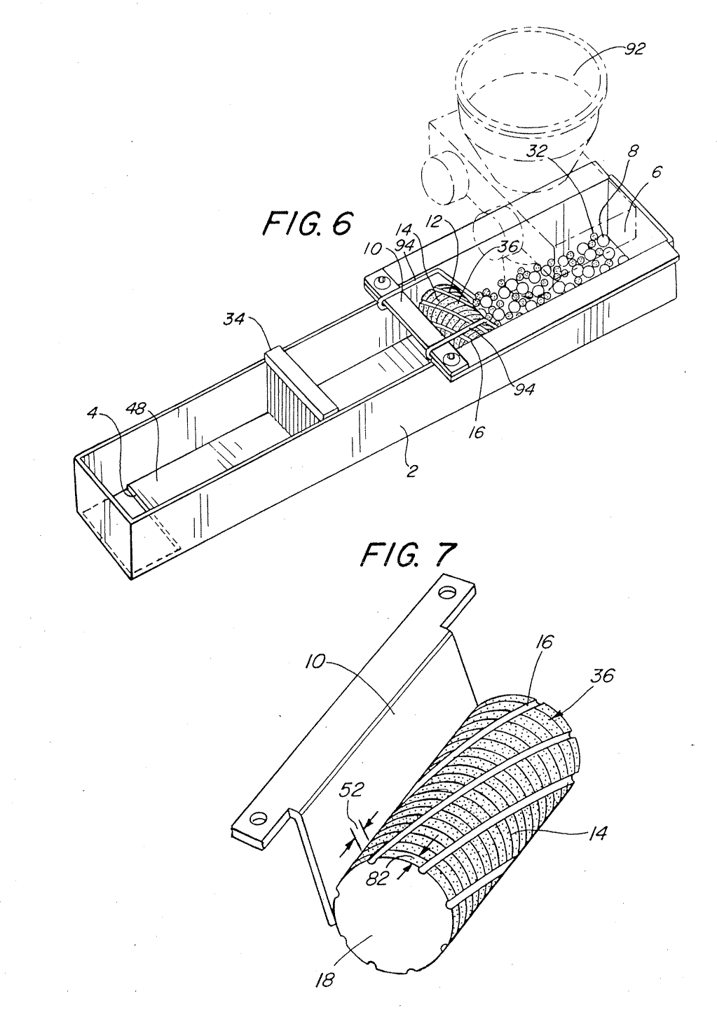

Preferably angle 22 is substantially equal to angle 42. This may reduce the extraneous movement of the separation unit 12 and help keep it relatively close to the retention device 10. This also assures that the retention device 10 contacts the separation unit 12 mostly while separation unit 12 is falling towards the feeder unit 2. This helps the rotation of the separation unit in a rotational direction 30. In addition, an optional guard device 94 as shown FIG. 6 may be added to the feeder unit 2 or to the retention device 10 upstream of the separation unit 12 to help keep the separation unit 12 relatively close to the retention device 10 and optionally regulate the sample flow rate towards the separation unit 12.

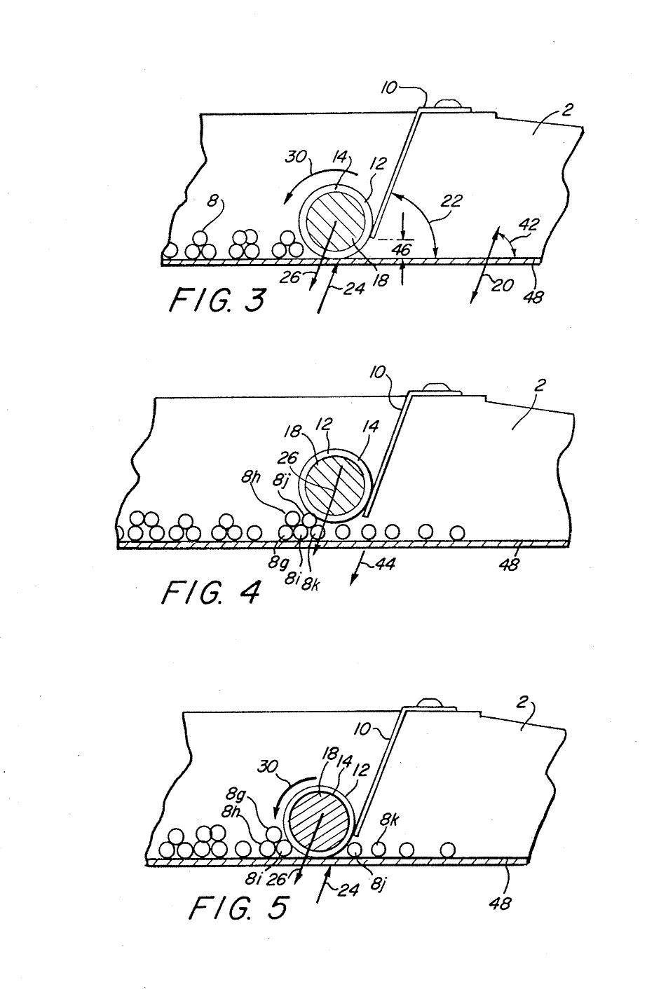

FIG. 4 is a close-up view of a relevant portion of FIG. 2. FIG. 4 depicts the feeder unit 2 moving in a downwards angle 42 with a separation unit 12, a retention device 10, and samples 8g, 8h, 8i, 8j, and 8k in an aggregated group. The separation unit moves at a downward angle 26 from gravity and also the contact it has with the retention device 2. However, the separation unit 12 does not move downwards at the same speed as the bottom support surface 48 of the feeder unit 2. Separation unit 12 comprises a cylindrical core 18 with a textured surface 14.

FIG. 5 is a close-up view of a relevant portion of FIG. 2. FIG. 5 depicts the feeder unit 2 moving in an upwards angle 24 making contact with the separation unit 12 moving in a downwards angel 26. As a result of the contact, the separation unit 12 bounces off the bottom support surface 48 of the feeder unit 2, rotates in a rotational direction 30, and also crushes aggregated group 8g, 8h, and 8i into an elementary particles 8j and 8k while moving them towards the sample delivery portion 4 of feeder unit 2.

FIG. 6 is a perspective view of an alternate embodiment of the invention. FIG. 6 shows the retention device 10 with a sample receiving portion 6, and sample delivery portion 4. As can be seen, the sample delivery portion 4 can be a variety of shapes and sizes. FIG. 6 also shows a hopper 92 in phantom which can be optionally used to distribute sample 8 to the sample receiving portion 6. Separation unit 12 is adjacent the retention device 10 and comprises a textured surface 14 with a plurality of grooves 16 on the textured surface 14. Textured surface 14 is shown coated with a non-stick substance 36 such as Teflon®. The non-stick substance 36 aids in preventing samples 8 from sticking to the separation unit 12.

In addition, an optional guard device 94 is added to the retention device 10 to help keep the separation unit 12 relatively close to the retention device 10 and to optionally regulate the sample flow towards the separation unit 12.

Also, additives such as flow agent 32 may be added to the sample 8 to aid in reducing the adhesive properties of the sample 8. This could allow the sample 8 to flow better and could reduce the potential for the sample 8 to stick to the separation unit.

A brush 34 may be added to the feeder unit 2 to further aid in keeping elementary particle separated.

FIG. 7 is a perspective view of the separation unit 12 adjacent the retention device 10. As can be seen, separation unit 12 comprises a cylindrical core 18 with a textured surface 14 and a plurality of spiral grooves 16. Separation unit 12 can also be optionally coated with a non-stick substance 36 such as Teflon®. The length 82 depicts how much the protrusions protrude from the cylindrical core 18. The pitch 52 is how much the protrusions turns. For example, if the protrusions are not spiral like a screw, the pitch would be 0. However, if the protrusions are spiral like a screw, then for example if the protrusions spiral at 7 turns per inch, it would have a pitch of approximately 0.143 inches per turn, which is equivalent to approximately 3.63 mm per turn. If the protrusions spiral at 18 turns per inch, it would have a pitch of approximately 0.056 inches per turn, which is equivalent to approximately 1.411 mm per turn. Likewise, if the protrusions spiral at 6 turns per inch, it would have a pitch of approximately 0.167 inches per turn, which is equivalent to approximately 4.233 mm per turn. It is contemplated that the pitch could be between 1 mm and 5 mm per turn. The length 82 and the pitch 52 of the textured surface 14 can be appropriately selected such that the separation unit 12 can reduce any aggregated groups in sample 8 into an elementary particle state. For example, if the particles of sample 8 had a diameter of 10 μm, the textured surface might have a smaller length 82 and pitch 52 than if the particles of sample 8 had a diameter of 1 mm.

The spiral grooves 16 can aid in crushing the sample into elementary particles, for example by, allowing the force from the textured surface 14 to be more concentrated when the textured surface 14 contacts the sample 8. This can allow the textured surface 14 to be more effective in crushing the sample 8 into elementary particles since there is a smaller surface area contacting the object while utilizing the same amount of force. The spiral grooves 16 could also, for example, allow the textured surface to better target the aggregated groups of the sample which are not elementary particles to crush them into elementary particles since the sample 8 which are already elementary particles can enter the spiral grooves 16 and be momentarily hidden from the crushing force of the textured surface. The spiral grooves 16 can also be formed to prevent the separation unit 12 from catching onto the retention device 10 when the separation unit 12 is rotating.

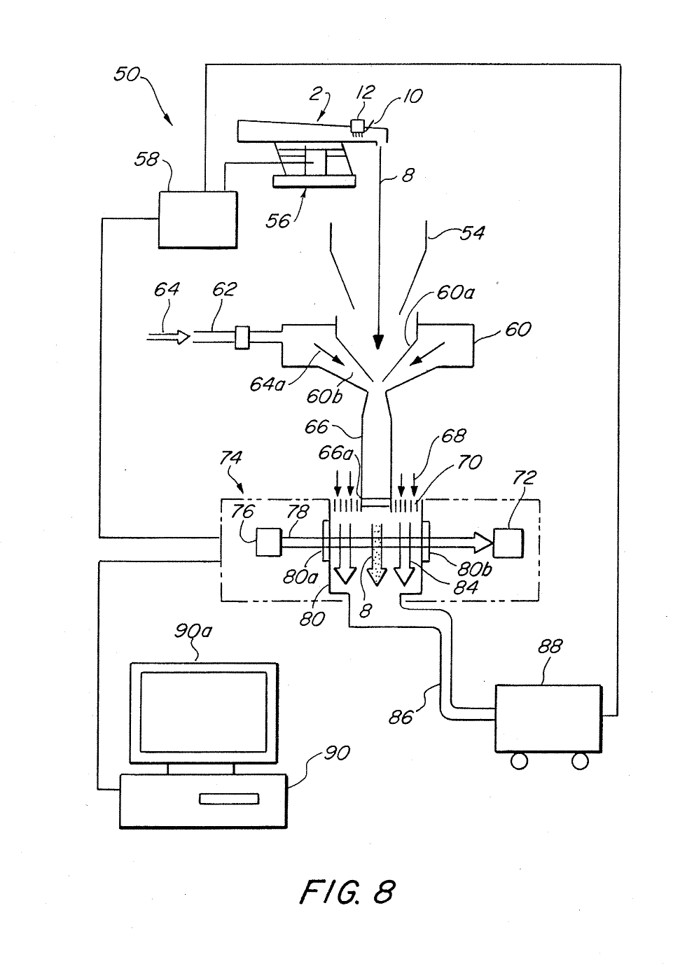

FIG. 8 is a schematic diagram of a dry particle-size distribution measuring apparatus into which the feeder unit 2 can be incorporated. In FIG. 8, 74 denotes a measuring section, and 50 denotes a sample supplying device disposed above the measuring section 74. The measuring section 74 is configured, for example, in the following manner.

The reference numeral 80 denotes a flow cell or measurement cell which is vertically disposed to receive the sample. Optical windows 80a and 80b are formed in opposed side faces of the flow cell 80, respectively. A laser light source 76 can irradiate a pulverized sample 8 that is dropped in the flow cell 80 with a laser beam 78. Laser source 76 is placed outside one of the optical window such as optical window 80a. An optical detecting section 72 which receives scattered light and/or diffracted light that is produced by irradiating the sample 8 with the laser beam 78 is placed outside the other optical window 80b. Measurement of the scattered light by the detecting section 72 permits a determination of particle size.

The reference number 60 denotes an ejector device which serves as a sample pulverizing section disposed immediately above the flow cell 80 and which includes a funnel-shaped section 60a. A sample guiding section 66 which communicates with the flow cell 80 is positioned under the funnel-shaped section 60a. A gas supply path 62 for compressed air 64 is connected to the ejector device 60. An air flow path 60b which guides the compressed air 64 supplied through the compressed air supply path 62, into the sample guiding section 66 is formed on the side of the lower face of the funnel-shaped section 60a, so that compressed air 64a flowing in the air flow path 60b is blown as a dispersion flow to the sample 8 being dropped from a feeder unit 2 of the sample supplying device 50.

The lower end of the sample guiding section 66 is insertedly connected to the flow cell 80. In a lower end portion of the guiding section, there is a partitioning section 66a which extends to the vicinities of the upper ends of the optical windows 80a and 80b. The reference numeral 70 denotes straightening guide vanes which are disposed around the portion of the sample guiding section 66 and are insertedly connected to the flow cell 80, so as to be in parallel with the partitioning section 66a, and through which outside air 68 is sucked or aspirated into the flow cell so that a sheath flow 84 is formed in the flow cell 80 by the sucked outside air 68 about the sample.

The reference numeral 86 denotes a sample recovery flow path which is formed on the lower end side of the flow cell 80, and which comprises a suction or vacuum apparatus 88. The reference numeral 54 denotes a hopper which is disposed above the ejector 60, and which is used for guiding the sample 8 that is dropped from the feeder unit 2 of the sample supplying device 50, into the ejector device 60.

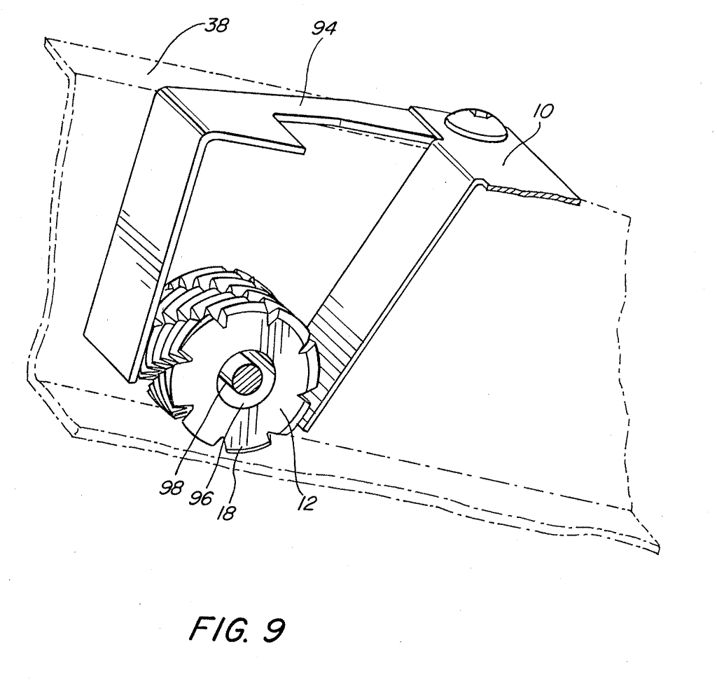

FIG. 9 is a cross-sectional perspective view of an alternate embodiment of the separation unit 12 adjacent the retention device 10 and the optional guard device 94. In this embodiment, the separation unit 12 can have a hollow portion 96 within cylindrical core 18. There can also optionally be a pin 98 which can be attached to side wall 38 and/or side wall 40 (shown in FIG. 1) and partially contained within hollow portion 96. The addition of pin 98 can help maintain the separation unit 12 relatively close to retention device 10.

It is possible that the hollow portion 96 does not extend throughout the cylindrical core 18 such as if pin 98 was attached only to side wall 38 or side wall 40. For example, the cylindrical core 18 can be solid in the middle with two hollow portions 96, it can be solid on one side with only one hollow portion at one end, or it can have a hollow portion 96 throughout the cylindrical core extending from one end of the cylindrical core to another end of the cylindrical core.

Furthermore, the guard device 94 can be of various shapes and sizes and be either solid or potentially have holes in it. In this embodiment, the guard is a solid piece that can also optionally regulate the sample flow rate towards the separation unit.

The sample supplying device 50 is configured mainly by the feeder unit 2 which accommodates the powdery and particulate sample 8, and a linear feeder 56 which can vibrate the feeder unit 2. The vibration of the linear feeder 56 is controlled by a controller 58.

Those skilled in the art will appreciate that various adaptations and modifications of the just-described preferred embodiment can be configured without departing from the scope and spirit of the invention. Therefore, it is to be understood that, within the scope of the amended claims, the invention may be practiced other than as specifically described herein.

Those skilled in the art will appreciate that various adaptations and modifications of the just-described preferred embodiment can be configured without departing from the scope and spirit of the invention. Therefore, it is to be understood that, within the scope of the amended claims, the invention may be practiced other than as specifically described herein.

What is claimed is:

1. An apparatus comprising:
a feeder unit which can receive and deliver a sample, the feeder unit including a sample receiving portion, a sample delivery portion, and a bottom support surface;
a retention device connected to the feeder unit, wherein the retention device is intermediate the sample receiving portion and the sample delivery portion of the feeder unit and wherein the retention device is raised a predetermined distance from the bottom support surface of the feeder unit; and
a separation unit located adjacent the retention device on the side encompassing the sample receiving portion of the feeder unit, wherein the separation unit crushes aggregated groups of the sample to an elementary particle state before the sample passes from the sample receiving portion of the feeder unit past the retention device and into the sample delivery portion of the feeder unit.

2. The apparatus of claim 1 wherein the separation unit is substantially cylindrical.

3. The apparatus of claim 2 wherein the separation unit further comprises a cylindrical core with a textured surface.

4. The apparatus of claim 3 wherein the cylindrical core of the separation unit further comprises a hollow portion, and
the feeder unit further comprises
a first side wall and a second side wall attached to the bottom support surface,
a pin attached to at least the first side wall or the second side wall, wherein the pin aids in maintaining the separation unit substantially adjacent the retention device.

5. The apparatus of claim 3 wherein there is an acute angle between the retention device and the bottom support surface of the feeder unit when the retention device and the bottom support surface of the feeder unit are viewed from the sample delivery portion of the feeder unit and there is an obtuse angle between the retention device and the bottom support surface of the feeder unit when the retention device and the bottom support surface of the feeder unit are viewed from the sample receiving portion of the feeder unit.

6. The apparatus of claim 5 wherein the separation unit rotates due to a vibration of the feeder unit in conjunction with contact between the separation unit and the feeder unit.

7. The apparatus of claim 6 wherein the retention device is at an angle substantially parallel to an angle of vibration of the feeder unit.

8. The apparatus of claim 7 wherein a rate of rotation of the separation unit varies according to a rate of vibration of the feeder unit.

9. The apparatus of claim 8 wherein when the feeder unit is viewed such that the sample receiving portion of the feeder unit is on the left side and the sample delivery portion of the feeder unit is on the right side, the separation unit rotates in a counter-clockwise direction.

10. The apparatus of claim 3 wherein the textured surface comprises a plurality of protrusions from the cylindrical core which contain a plurality of spiral grooves.

11. The apparatus of claim 10 wherein the plurality of protrusions are sufficiently spaced apart such that a space between each protrusion of the plurality of protrusions is such that it determines the size of the elementary particles.

12. The apparatus of claim 3 wherein a pitch of the protrusions determines the size of the elementary particles.

13. The apparatus of claim 12 wherein the pitch of the protrusions is between 1 mm per turn and 5 mm per turn.

14. The apparatus of claim 3 wherein the separation unit is partially coated with a non-stick material.

15. The apparatus of claim 8 wherein the rate of vibration of the feeder unit is variable to ensure a flow rate of the sample into the outlet is relatively constant.

16. The apparatus of claim 1 wherein
the feeder unit further comprises a first side wall and a second side wall attached to the bottom support surface; and
the retention device further comprises a first edge and a second edge, wherein there is a first gap between the first edge of the retention device and the first side wall of the feeder unit and there is a second gap between the second edge of the retention device and the second side wall of the feeder unit.

17. The apparatus of claim 6 further comprising a guard device attached to the retention device.

18. An apparatus for supplying dry particles to a dry particle size distribution measuring apparatus comprising:
a feeder unit which can receive and transport a sample, the feeder unit including a sample receiving portion, a sample delivery portion, and a bottom support surface;
a retention device connected to the feeder unit, wherein the retention device is intermediate the sample receiving portion and the sample delivery portion of the feeder unit and wherein the retention device is raised a predetermined distance from the bottom support surface of the feeder unit,
wherein there is an acute angle between the retention device and the bottom support surface of the feeder unit when the retention device and the bottom support surface of the feeder unit are viewed from the sample delivery portion of the feeder unit, and there is an obtuse angle between the retention device and the bottom support surface of the feeder unit when the retention device and the bottom support surface of the feeder unit are viewed from the sample receiving portion of the feeder unit; and
a separation unit located adjacent the retention device on the side encompassing the sample receiving portion of the feeder unit, the separation unit comprising a cylindrical core with a textured surface, wherein the separation unit pulverizes aggregated groups of the sample to an elementary particle state before the sample passes from the sample receiving portion of the feeder unit past the retention device and into the sample delivery portion of the feeder unit wherein the dry particles are separated into an elementary particle state when released from the sample delivery portion.

19. The apparatus of claim 18 wherein the separation unit rotates due to a vibration of the feeder unit in conjunction with contact between the separation unit and the feeder unit.

20. The apparatus of claim 19 wherein a rate of rotation of the separation unit varies according to an intensity of vibration of the feeder unit.

21. The apparatus of claim 20 wherein when the feeder unit is viewed such that the sample receiving portion of the feeder unit is on the left side and the sample delivery portion of the feeder unit is on the right side, the separation unit rotates in a counter-clockwise direction.

22. The apparatus of claim 21 wherein the textured surface comprises a plurality of protrusions from the cylindrical core which contain a plurality of spiral grooves.

23. The apparatus of claim 22 wherein the plurality of protrusions are sufficiently spaced apart such that a space between each protrusion of the plurality of protrusions is larger than most of the aggregated groups of the sample.

24. The apparatus of claim 18 wherein the separation unit is partially coated with a non-stick material.

25. In a dry particle size distribution measuring apparatus for measuring particle sizes of elementary particle samples, the improvement of a sample supplying apparatus comprising:
a feeder unit which can receive and transport a sample, the feeder unit including a sample receiving portion, a sample delivery portion, and a bottom support surface;
a retention device connected to the feeder unit, wherein the retention device is intermediate the sample receiving portion and the sample delivery portion of the feeder unit and wherein the retention device is raised a predetermined distance from the bottom support surface of the feeder unit,
wherein there is an acute angle between the retention device and the bottom support surface of the feeder unit when the retention device and the bottom support surface of the feeder unit are viewed from the sample delivery portion of the feeder unit, and there is an obtuse angle between the retention device and the bottom support surface of the feeder unit when the retention device and the bottom support surface of the feeder unit are viewed from the sample receiving portion of the feeder unit; and
a separation unit comprising a cylindrical core with a textured surface located adjacent the retention device on the side encompassing the sample receiving portion of the feeder unit, the separation unit rotates due to a vibration of the feeder unit in conjunction with contact between the separation unit and the feeder unit at a rate of rotation varying according to an intensity of vibration of the feeder unit,
wherein the separation unit pulverizing aggregated groups of the sample to an elementary particle state before the sample passes from the sample receiving portion of the feeder unit past the retention device and into the sample delivery portion of the feeder unit.

26. The apparatus of claim 25 wherein when the feeder unit is viewed such that the sample receiving portion of the feeder unit is on the left side and the sample delivery portion of the feeder unit is on the right side, the separation unit rotates in a counter-clockwise direction

27. The apparatus of claim 26 wherein the separation unit is partially coated with a non-stick material, the textured surface comprises a plurality of protrusions from the cylindrical core which contain a plurality of spiral grooves, and the plurality of protrusions are sufficiently spaced apart such that a space between each protrusion of the plurality of protrusions is larger than most of the aggregated groups of the sample.
